(19) United States
(12) Patent Application Publication
(10) Pub. No.: US 2012/0023314 A1
(43) Pub. Date: Jan. 26, 2012

(54) PAIRED EXECUTION SCHEDULING OF DEPENDENT MICRO-OPERATIONS

(76) Inventors: Matthew M. Crum, Austin, TX (US); Michael D. Achenbach, Austin, TX (US); Betty A. McDaniel, Austin, TX (US); Benjamin T. Sander, Austin, TX (US)

(21) Appl. No.: 12/840,835

(22) Filed: Jul. 21, 2010

(51) Int. Cl. G06F 9/30; G06F 9/38

(52) U.S. Cl. 712/214; 712/216; 712/E09.016; 712/E09.045

(57) ABSTRACT

A method and mechanism for reducing latency of a multi-cycle scheduler within a processor. A processor comprises a front end pipeline that determines data dependencies between instructions prior to a scheduling pipe stage. For each data dependency, a distance value is determined based on a number of instructions a younger dependent instruction is located from a corresponding older (in program order) instruction. When the younger dependent instruction is allocated an entry in a multi-cycle scheduler, this distance value may be used to locate an entry storing the older instruction in the scheduler. When the older instruction is picked for issue, the younger dependent instruction is marked as pre-picked. In an immediately subsequent clock cycle, the younger dependent instruction may be picked for issue, thereby reducing the latency of the multi-cycle scheduler.

### BACKGROUND OF THE INVENTION

1. Field of the Invention

This invention relates to computing systems, and more particularly, to reducing latency of a multi-cycle scheduler within a processor.

2. Description of the Relevant Art

Modern processor designs feature higher operating frequencies, greater complexity, and increased pipeline depth compared to earlier generations. While changes have resulted in improved device speed, the higher clock frequencies allow fewer levels of logic to fit within a single clock cycle compared to previous generations. For example, a scheduler that determines when instructions are eligible for issue may require multiple cycles to check a number of conditions, such as dependency resolution, and decide which instructions to select. The number of cycles required by the scheduler can impact the critical path latency experienced by chains of dependent instructions, the length of which may correspond to several factors including the size of the scheduler, instruction dependencies, instruction latencies, the number and functionality of pipeline stages within a corresponding microarchitecture, and speculative instruction effects such as misprediction and recovery.

Modern schedulers may select multiple dispatched instructions out of program order to enable more instruction level parallelism, which yields higher performance. Also, out-of-order (o-o-o) issue and execution of instructions helps hide instruction latencies. However, if an application has a long dependency chain of instructions, the benefits of o-o-o issue and execution may be greatly reduced. In addition, if the scheduler is a multi-cycle scheduler, the benefits are further reduced as extra cycles are incorporated within the waiting dependent instructions.

One solution to reduce the latency of long dependency chains of instructions is scheduling independent instructions between dependent instructions to hide latencies. However, this type of scheduling does not address the actual critical path problem itself. In many cases, the critical path latency cannot be completely overlapped, or hidden, by the intermittent scheduling of independent instructions. A second solution is writing or re-writing software to avoid long dependency chains of instructions. However, this solution may not be complete as software-based approaches lack full visibility into the hardware scheduling of instructions. Additionally, software-based approaches comprise costly rewrites and recompiles.

In addition to the above, parasitic capacitances and wire route delays continue to increase with each newer processor generation. Therefore, wire delays limit the dimension of many processor structures such as a scheduler. Within a scheduler, the delay of a wide o-o-o selection path is proportional to the number of entries of the scheduler. In order for a processor to achieve high performance, the scheduler is pressured to supply a sufficient number of instructions to functional units each clock cycle despite the various constraints mentioned above. As stated earlier, higher clock frequencies allow fewer levels of logic to fit within a single clock cycle.

In view of the above, efficient methods and mechanisms for reducing latency of a multi-cycle scheduler within a processor are desired.

### SUMMARY OF EMBODIMENTS OF THE INVENTION

Systems and methods for reducing latency of a multi-cycle scheduler within a processor are contemplated.

In one embodiment, a processor comprises a front-end pipeline that determines data dependencies between instructions prior to a scheduling pipe stage. For each data dependency, a younger in program order instruction (child instruction) has a source operand dependent on a destination operand of an older in program order instruction (parent instruction). In addition, logic within the front-end pipeline associates a distance with the child instruction. This distance value may be measured as a number of instructions the child instruction is located from the parent instruction in program order. When the child instruction is allocated an entry in a multi-cycle scheduler, this distance value may be used to locate an entry storing the parent instruction in the scheduler. Alternatively, an absolute pointer may be used to locate the entry storing the parent instruction in the scheduler. The use of the distance value or the absolute pointer greatly simplifies logic for determining data dependencies within the scheduler. This simplification may reduce a critical path latency. After locating the parent instruction, logic detects whether the parent instruction is picked for issue to a corresponding execution unit. If this is the case, the child instruction is marked as pre-picked. In an immediate subsequent clock cycle, the child instruction may be picked for issue, thereby reducing the latency of the multi-cycle scheduler by a clock cycle. In other embodiments, greater than a single clock cycle may be saved (e.g., if a scheduler loop is more than two cycles). For long dependency chains in code, the elimination of the clock cycle per child instruction may greatly increase throughput for the processor. In addition, embodiments are contemplated where multiple parent operations are detected and linked by a child during a pre-scheduling phase.

These and other embodiments will be further appreciated upon reference to the following description and drawings.

### BRIEF DESCRIPTION OF THE DRAWINGS

FIG. 1 is a generalized block diagram of one embodiment of a processor core.

FIG. 2A is a generalized block diagram illustrating one embodiment of pipeline stages of a processor core.

FIG. 2B is a generalized block diagram illustrating another embodiment of pipeline stages of a processor core.

FIG. 3 is a generalized block diagram of one embodiment of instruction dependency logic across multiple pipe stages.

FIG. 4 is a flow diagram of one embodiment of a method for reducing latency of a multi-cycle scheduler.

FIG. 5 is a flow diagram of one embodiment of a method for reducing latency of a multi-cycle scheduler.

While the invention is susceptible to various modifications and alternative forms, specific embodiments are shown by way of example in the drawings and are herein described in detail. It should be understood, however, that drawings and detailed description thereto are not intended to limit the invention to the particular form disclosed, but on the contrary, the invention is to cover all modifications, equivalents and alternatives falling within the spirit and scope of the present invention as defined by the appended claims.

### DETAILED DESCRIPTION

In the following description, numerous specific details are set forth to provide a thorough understanding of the present invention. However, one having ordinary skill in the art should recognize that the invention might be practiced without these specific details. In some instances, well-known circuits, structures, and techniques have not been shown in detail to avoid obscuring the present invention.

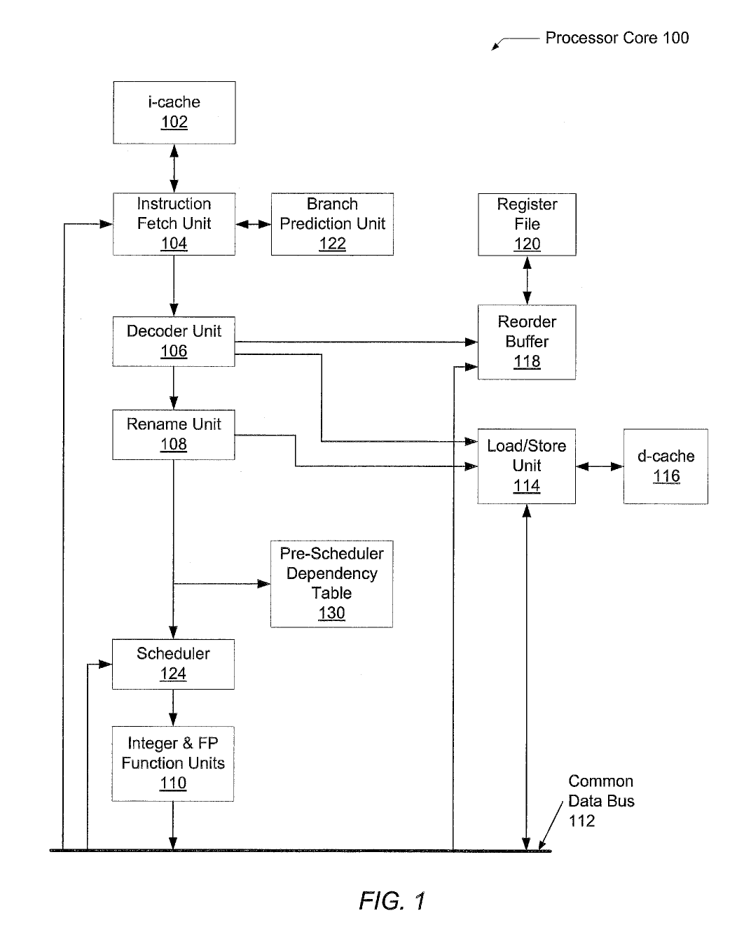

Referring to FIG. 1, one embodiment of a generalized block diagram of a processor core 100 that performs superscalar out-of-order execution is shown. Core 100 may include circuitry for executing instructions according to a predefined instruction set. For example, the SPARC® instruction set architecture (ISA) may be selected. Alternatively, the x86, x86-64®, Alpha®, PowerPC®, MIPS®, PA-RISC®, or any other instruction set architecture may be selected. In one embodiment, core 100 may be included in a single-processor configuration. In another embodiment, core 100 may be included in a multi-processor configuration. In other embodiments, core 100 may be included in a multi-core configuration within a processing node of a multi-node system.

An instruction-cache (i-cache) 102 may store instructions for a software application and a data-cache (d-cache) 116 may store data used in computations performed by the instructions. Generally speaking, a cache may store one or more blocks, each of which is a copy of data stored at a corresponding address in the system memory, which is not shown. As used herein, a “block” is a set of bytes stored in contiguous memory locations, which are treated as a unit for coherency purposes. In some embodiments, a block may also be the unit of allocation and deallocation in a cache. The number of bytes in a block may be varied according to design choice, and may be of any size. As an example, 32 byte and 64 byte blocks are often used.

Caches 102 and 116, as shown, may be integrated within processor core 100. Alternatively, caches 102 and 116 may be coupled to core 100 in a backside cache configuration or an inline configuration, as desired. Still further, caches 102 and 116 may be implemented as a hierarchy of caches. In one embodiment, caches 102 and 116 each represent L1 and L2 cache structures. In another embodiment, caches 102 and 116 may share another cache (not shown) implemented as an L3 cache structure. Alternatively, each of caches 102 and 116 each represent an L1 cache structure and a shared cache structure may be an L2 cache structure. Other combinations are possible and may be chosen.

Caches 102 and 116 and any shared caches may each include a cache memory coupled to a corresponding cache controller. If core 100 is included in a multi-core system, a memory controller (not shown) may be used for routing packets, receiving packets for data processing, and synchronize the packets to an internal clock used by logic within core 100. Also, in a multi-core system, multiple copies of a memory block may exist in multiple caches of multiple processors. Accordingly, a cache coherency circuit may be included in the memory controller. Since a given block may be stored in one or more caches, and further since one of the cached copies may be modified with respect to the copy in the memory system, computing systems often maintain coherency between the caches and the memory system. Coherency is maintained if an update to a block is reflected by other cache copies of the block according to a predefined coherency protocol. Various specific coherency protocols are well known.

The instruction fetch unit (IFU) 104 may fetch multiple instructions from the i-cache 102 per clock cycle if there are no i-cache misses. The IFU 104 may include a program counter (PC) register that holds a pointer to an address of the next instructions to fetch from the i-cache 102. A branch prediction unit 122 may be coupled to the IFU 104. Unit 122 may be configured to predict information of instructions that change the flow of an instruction stream from executing a next sequential instruction. An example of prediction information may include a 1-bit value comprising a prediction of whether or not a condition is satisfied that determines if a next sequential instruction should be executed or an instruction in another location in the instruction stream should be executed next. Another example of prediction information may be an address of a next instruction to execute that differs from the next sequential instruction. The determination of the actual outcome and whether or not the prediction was correct may occur in a later pipeline stage. Also, in an alternative embodiment, IFU 104 may comprise unit 122, rather than have the two be implemented as two separate units.

The decoder unit 106 decodes the opcodes of the multiple fetched instructions. In some embodiments, the decoder unit 106 may divide a single instruction into two or more micro-operations (micro-ops). The micro-ops may be processed by subsequent pipeline stages and executed out-of-order. However, the micro-ops may not be committed until each micro-op corresponding to an original instruction is ready. AS used herein, the processing of an “instruction” in core 100 may refer to the processing of the instruction as whole or the processing of an individual micro-op comprised within the instruction. Both microarchitecture choices are available to a designer and contemplated.

Decoder unit 106 may allocate entries in an in-order retirement queue, such as reorder buffer 118, in reservation stations, and in a load/store unit 114. In the embodiment shown, a reservation station may comprise the rename unit 108 and the scheduler 124, which are shown as separate units. The flow of instructions from the decoder unit 106 to the allocation of entries in the rename unit 108 may be referred to as dispatch. The rename unit 108 may be configured to perform register renaming for the fetched instructions.

Register renaming may facilitate the elimination of certain dependencies between instructions (e.g., write-after-read or “false” dependencies), which may in turn prevent unnecessary serialization of instruction execution. In one embodiment, rename unit 108 may be configured to rename the logical (i.e., architected) destination registers specified by instructions by mapping them to a physical register space, resolving false dependencies in the process. In some embodiments, rename unit 108 may maintain mapping tables that reflect the relationship between logical registers and the physical registers to which they are mapped.

Once decoded and renamed, instructions may be ready to be scheduled for execution. The scheduler 124 may act as an instruction queue where instructions wait until their operands become available. When operands are available and hardware resources are also available, an instruction may be issued out-of-order from the scheduler 124 to the integer and floating-point functional units 110 or the load/store unit 114. The functional units 110 may include arithmetic logic units (ALU's) for computational calculations such as addition, subtraction, multiplication, division, and square root. Logic may be included to determine an outcome of a branch instruction and to compare the calculated outcome with the predicted value. If there is not a match, a misprediction occurred, and the subsequent instructions after the branch instruction need to be removed and a new fetch with the correct PC value needs to be performed.

Prior to allocating an entry in the scheduler 124 for a given instruction, the source operand identifier, or simply source operand, of the given instruction may be used for comparisons to destination operands of older instructions in program order. A separate destination operand may be stored in each entry of the pre-scheduler dependency table 130. The access of the entries of the pre-scheduler dependency table 130 and the comparisons performed are shown in FIG. 1 between register renaming and allocation into the scheduler 124. However, the access of the pre-scheduler dependency table 130 may occur in any pipe stage prior to allocation into the scheduler 124. Alternatively, a pre-scheduler dependency table 130 may not be utilized to identify instruction dependencies. Rather, combinatorial logic may perform comparisons both within a chosen pipe stage and across other pipe stages to perform instruction dependency analysis. The location of source and destination operands for instructions may be known for each set of pipeline registers. Whether a pre-scheduler dependency table is used, combinatorial logic accessing pipeline registers is used, or another mechanism is used, the instruction dependency analysis determines for each source operand of a given instruction whether a dependency exists with a destination operand of an older instruction.

In an embodiment with a pre-scheduler dependency table, each entry in the pre-scheduler dependency table 130 may store a destination operand identifier of a different older instruction in program order. For an N-instruction-wide superscalar core, the pre-scheduler dependency table 130 may store a destination operand identifier for instructions in later pipe stages in the pipeline. For example, for a 3-wide superscalar core, each of the 3 instructions (instructions G, H, J in program order) in a pipe stage M may compare corresponding source operands to destination operands stored in the pre-scheduler dependency table 130, wherein the destination operands correspond to the 3 instructions (instructions D, E, F in program order) in pipe stage M+1. In addition, each of the 3 instructions (instructions G, H, J in program order) in pipe stage M may compare corresponding source operands to destination operands of older instructions within the 3 instructions (instructions G, H, J in program order) in pipe stage M. For example, instruction J may compare source operands with the destination operands of instructions G and H. Similarly, instruction H may compare source operands with the destination operand of instructions G.

Continuing with the example above, in other embodiments, the pre-scheduler dependency table 130 may store a destination operand identifier for more than N older instructions in program order. For example, for the 3-wide superscalar core, each of the 3 instructions (instructions G, H, J in program order) in the pipe stage M may compare corresponding source operands to destination operands stored in the pre-scheduler dependency table 130. These destination operands correspond to the 3 instructions (instructions D, E, F in program order) in pipe stage M+1 and the 3 instructions (instructions A, B, C in program order) in pipe stage M+2. Now the pre-scheduler dependency table 130 has six entries versus three entries. The number of older instructions may be expanded in this manner to later pipe stages M+3 and so forth. As the number of older instructions per pipe stage and the number of pipe stages used for these comparisons increase, the window of opportunity to detect a data dependency between a parent instruction and a child instruction also increases. However, the hardware cost of supporting this window also increases.

A match resulting from a comparison of a source operand of a given instruction and a destination operand of an older instruction stored in the table 130 detects a data dependency between the given instruction and the corresponding older instruction. Since register renaming may be used in rename unit 108, a WAW hazard may have already been avoided. When a match is found, status bits associated with the given instruction and traveling through the pipeline with the given instruction may be updated to indicate the match. In addition, an identifier of the matching older instruction may be stored. In another embodiment without a pre-scheduler dependency table, each of the comparisons described above may occur between the source operands described above and destination operands stored in known locations within pipeline registers. For example, each of the 3 instructions (instructions G, H, J in program order) in the pipe stage M may compare corresponding source operands to destination operands stored in known locations in the pipeline registers associated with pipe stage M+1. The destination operands may correspond to the 3 instructions (instructions D, E, F in program order) in pipe stage M+1. In an alternative embodiment, wherein the scheduler has a 2-cycle latency, prior to allocation in the scheduler, the given instruction may compare its source operands to the destination operands of each instruction currently being processed in a same pipe stage as the given instruction. Therefore, no table may be utilized. In addition, when a table is utilized, the comparisons just described may occur concurrently with comparisons performed with entries in the table.

Continuing with the status bits described above, in one embodiment, these status bits may indicate a distance between the given instruction and the matching older instruction. This distance value may be measured as a number of instructions the first instruction is located from the second instruction in program order. For example, if a matching older instruction is one instruction older in program order than the given instruction, then the status bit(s) may indicate a value of 1. If the matching instruction is two instructions older in program order than the given instruction, then the status bits may indicate a value of 2, and so forth. If no match is found, then the status bits may indicate a value of 0.

As the number of entries stored in the pre-scheduler dependency table 130 increases and the width of the superscalar core increases, so does the number of bits used in the status bits. Therefore, as the window of opportunity to detect a data dependency increases, so does the hardware cost of supporting this window. In one embodiment, a designer may use pre-silicon processor model simulations to determine a size of the window to support. A detection of a data dependency (RAW hazard) as described above prior to allocating the given instruction in the scheduler 124 may reduce the number of levels of logic utilized in the scheduler 124 for picking one or more instructions from a pool of instructions to issue to the function units 110. Therefore, a critical path may be reduced.

As used herein, the given instruction used in the examples above may be referred to as a child instruction. The older instruction in program order that the child instruction is dependent on may be referred to as a parent instruction. The status bits that may be used to locate the parent instruction with respect to the child instruction may be referred to as a parent pointer. This pointer value may be a relative reference such as a distance between the parent and the child instructions in program order. Alternatively this pointer value may be an absolute reference such as an entry number of an entry in the scheduler 124 allocated for the parent instruction.

When an entry in the scheduler 124 is allocated for a child instruction, the parent pointer value may be used to locate a corresponding parent instruction in the scheduler 124. When the parent instruction is picked to issue to a corresponding execution unit in the function units 110, the child instruction may be marked in a manner to indicate the child instruction is pre-picked. A pre-picked status may indicate the child instruction is eligible for being picked to issue in an immediate subsequent pipe stage. The marking of the child instruction may include setting a particular bit in a status field in an entry in the scheduler 124 corresponding to the child instruction. This marking of the child instruction may occur when the child instruction already has an allocated entry in the scheduler 124, or alternatively, when the child instruction is currently being allocated in a corresponding entry.

For a multi-cycle scheduler utilizing a pre-picked status field, a child instruction that would have been scheduled for execution two or more cycles after a corresponding critical-path parent instruction is able to issue for execution in one cycle after the parent instruction is issued. Since the dependency determination occurs earlier in the pipeline, any timing pressure on the scheduling logic may be alleviated. For example, for an n-cycle scheduler, the child instruction may no longer have to be picked n cycles after the parent instruction, but the child instruction may be picked n−1 cycles after the parent instruction is picked. Generally speaking, if the dependency determination consumes m cycles, wherein 1≦m≦n, and this determination occurs earlier in a pipe stage prior to instruction scheduling, then the child instruction may be picked n-m cycles after the parent instruction is picked. Each of the parent and the child instructions may still broadcast corresponding tags, write back to the register file, and bypass results on an early result bus.

Continuing with the components of core 100, the load/store unit 114 may include queues and logic to execute a memory access instruction. Also, verification logic may reside in the load/store unit 114 to ensure a load instruction received forwarded data, or bypass data, from the correct youngest store instruction.

Results from the functional units 110 and the load/store unit 114 may be presented on a common data bus 112. The results may be sent to the reorder buffer 118. Here, an instruction that receives its results, is marked for retirement, and is head-of-the-queue may have its results sent to the register file 120. The register file 120 may hold the architectural state of the general-purpose registers of processor core 100. In one embodiment, register file 120 may contain 32 32-bit registers. Then the instruction in the reorder buffer may be retired in-order and its head-of-queue pointer may be adjusted to the subsequent instruction in program order.

The results on the common data bus 112 may be sent to the scheduler 124 in order to forward values to operands of instructions waiting for the results. In the embodiment shown, only one scheduler 124 is shown, but multiple schedulers may be utilizes, such as one scheduler for integer operations and one scheduler for floating-point operations. When these waiting instructions have values for their operands and hardware resources are available to execute the instructions, they may be issued out-of-order from the scheduler 124 to the appropriate resources in the functional units 110 or the load/store unit 114. Results on the common data bus 112 may be routed to the IFU 104 and unit 122 in order to update control flow prediction information and/or the PC value.

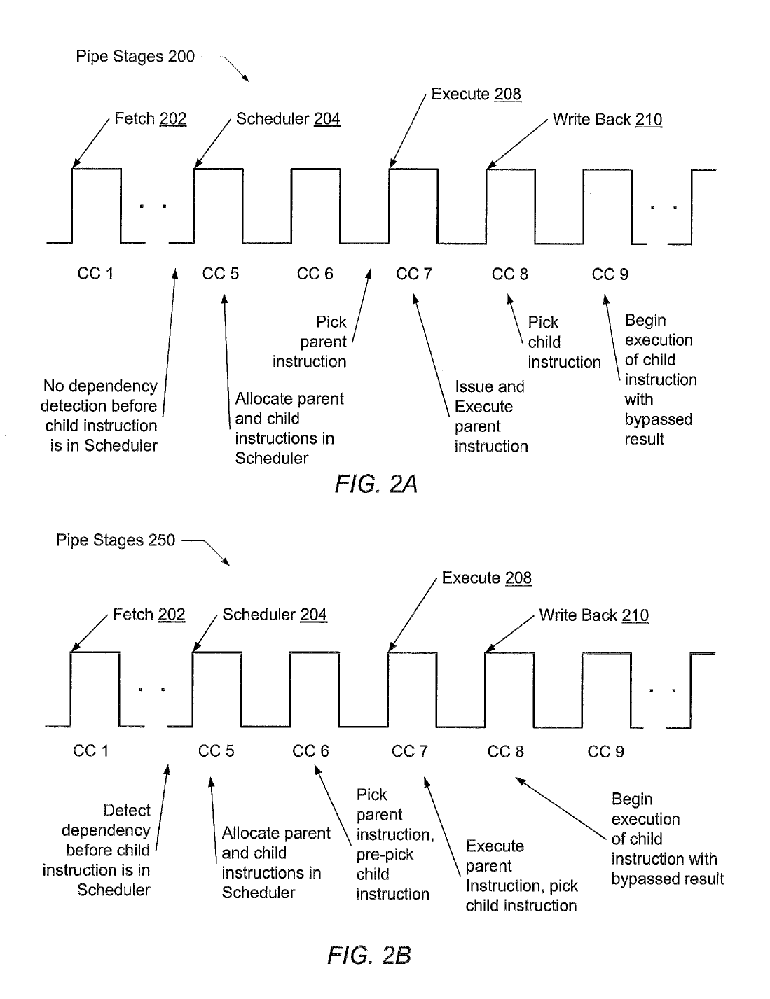

Referring now to FIG. 2A, one embodiment of pipeline stages 200 of a processor core with signals indicating generation of results is shown. Here, in the embodiment shown, each pipeline stage, such as Fetch 202 is shown as a single clock cycle to simplify the illustration, except for Scheduler 204. The logic for scheduler 124 comprises at least two cycles (clock cycle 5 and clock cycle 6). In the Scheduler 204 pipe stage the instructions are allocated in a scheduler array. Selection logic may begin to determine which instructions should be issued to a corresponding execution unit. This selection logic may be a long path and utilize at least two clock cycles.

Due to the size of a scheduler array, data dependencies, source operand readiness, and so forth, the logic in scheduler 124 may utilize a minimum of 2 clock cycles to determine a given instruction should be selected for issue to a corresponding execution unit. Two cycles are shown for illustrative purposes, but the complexity of the logic may utilize more than two cycles in particular microarchitecture implementations (a fully-associative array versus a static assigned array, multi-threading versus single threading, and so forth). When the selection logic within scheduler 124 comprises two or more cycles, performance may suffer if the extra cycles are not hidden by instruction level parallelism (ILP) techniques such as out-of-order execution. The problem grows when code includes a long data dependency chain. If some of this qualifying logic in the scheduler 124 could be performed before the given instruction is allocated in the scheduler 124 and a corresponding result is stored with the given instruction, then the logic within the scheduler may utilize a single clock cycle.

Returning to the pipe stages shown in FIG. 2A, in other embodiments of a pipeline, one or more phases of a clock cycle and a mix of full clock cycles and phases may be used for the pipe stages. Generally speaking, pipeline stages Fetch 202, Scheduler 204, Execute 208, and Write Back 210 may each be implemented with multiple clock cycles. One or more pipeline stages not shown or described may be present in addition to pipeline stages 202-210. For example, decoding, renaming, and other pipeline stages that may be present between Fetch 302 and Scheduler 204 are not shown for ease of illustration.

There may be multiple execution pipelines, such as one for integer operations, one for floating-point operations, a third for memory operations, another for graphics processing and/or cryptographic operations, and so forth. The embodiment of pipe stages 200 shown in FIG. 2A is for illustrating the indication of generated results to younger (in program order) dependent instructions. The embodiment shown is not meant to illustrate an entire processor pipeline.

In one embodiment, when results are generated by older (in program order) instructions, such as the completion of pipe stage Execute 208, a broadcast of this completion may occur. In one embodiment, the result tags may be broadcast. For example, during the Write Back 210 pipe stage, the results of an integer add instruction may be presented on a results bus. Control logic may detect a functional unit has completed its task (such as in pipe stage Write Back 210). Accordingly, certain control signals may be asserted to indicate to other processor resources that this particular instruction has results available for use. A broadcast signal and storage in a flip-flop is provided as an example. In other embodiments, other control signals may be used in addition to or in place of this broadcast signal. Other control signals may include a corresponding valid signal and results tags routed to comparators within the scheduler 124, a corresponding valid signal and decoded scheduler entry number input to a word line driver, or otherwise. In the example shown, the signaling of available results occurs in pipe stage Write Back 210 in clock cycle 8. This assertion occurs following a last execution clock cycle of an execution pipeline. In this example, the execute pipeline (Execute 208) is a single pipe stage shown in clock cycle 7.

In the clock cycle following the pipe stage Write Back 210, clock cycle 9, younger (in program order) instructions may verify their source operands are ready, since a results broadcast has been conveyed. The logic within the scheduler 124 may pick one or more of these younger instructions that were previously waiting for the results. As shown in FIG. 2A, both an older instruction (parent instruction) and a dependent younger instruction (child instruction) may be allocated in the scheduler in CC 5. The scheduling logic may begin to determine whether these instructions should be issued to a corresponding execution unit. The logic may utilize at least two cycles, such as CC 5 and CC 6. The parent instruction may be picked for issue to an execution unit in CC 6. The child instruction is not picked, since at least one source operand is depending on the parent instruction. The child instruction may not be picked for issue until CC 8 when both the results of the parent instruction are available and the selection logic utilized at least two clock cycles to determine which instructions to select for issue. The bypassing of results may be used to obtain the result of the parent instruction rather than wait another clock cycle to read the results from a register file.

In order to improve throughput and to begin the execution of the child instruction at an earlier time, some of this qualifying logic in the scheduler 124 could be performed before the given instruction is allocated in the scheduler 124 and a corresponding result is stored with the given instruction, then the logic within the scheduler may utilize a single clock cycle. For example, the pre-scheduler dependency table 130 may be accessed prior to the Scheduler pipe stage shown as CC 5 in FIG. 2A. Removing a check for data dependencies from the scheduler logic may allow the child instruction to be picked for issue in an earlier clock cycle. Therefore, throughput may be increased without relying on ILP techniques that may or may not hide all extra cycle latencies in a long dependency chain in code.

Turning now to FIG. 2B, one embodiment of pipeline stages 250 of a processor core with a single-cycle latency scheduler is shown. Pipe stages with the same functionality as pipe stages in FIG. 2A are numbered identically. In one embodiment, the pre-scheduler dependency table 130 may be accessed prior to the Scheduler pipe stage shown as CC 5 in FIG. 2B. Removing a check for data dependencies from the scheduler logic may allow the scheduling logic to comprise a single-cycle latency rather than a 2-cycle latency. When the child instruction is allocated in the scheduler in CC 5, a pointer may be stored in its allocated entry that indicates the location of the parent instruction in the scheduler 124. Each clock cycle, logic may check this location to verify whether the parent instruction is picked. This pointer information removes several levels of logic from the scheduler logic since finding a data dependency is already done.

In CC 6, the parent instruction is picked. Accordingly, logic determines the child instruction may be pre-picked. In the example shown, the parent instruction has a single-cycle execution latency and bypassing of a corresponding result is utilized. Therefore, the child instruction may be picked for issue to a corresponding execution unit in CC 7, which is a clock cycle earlier than the 2-cycle scheduler example shown in FIG. 2A. In another example, the child instruction may have been written in the scheduler in CC 6 and the logic may still pre-pick the child instruction.

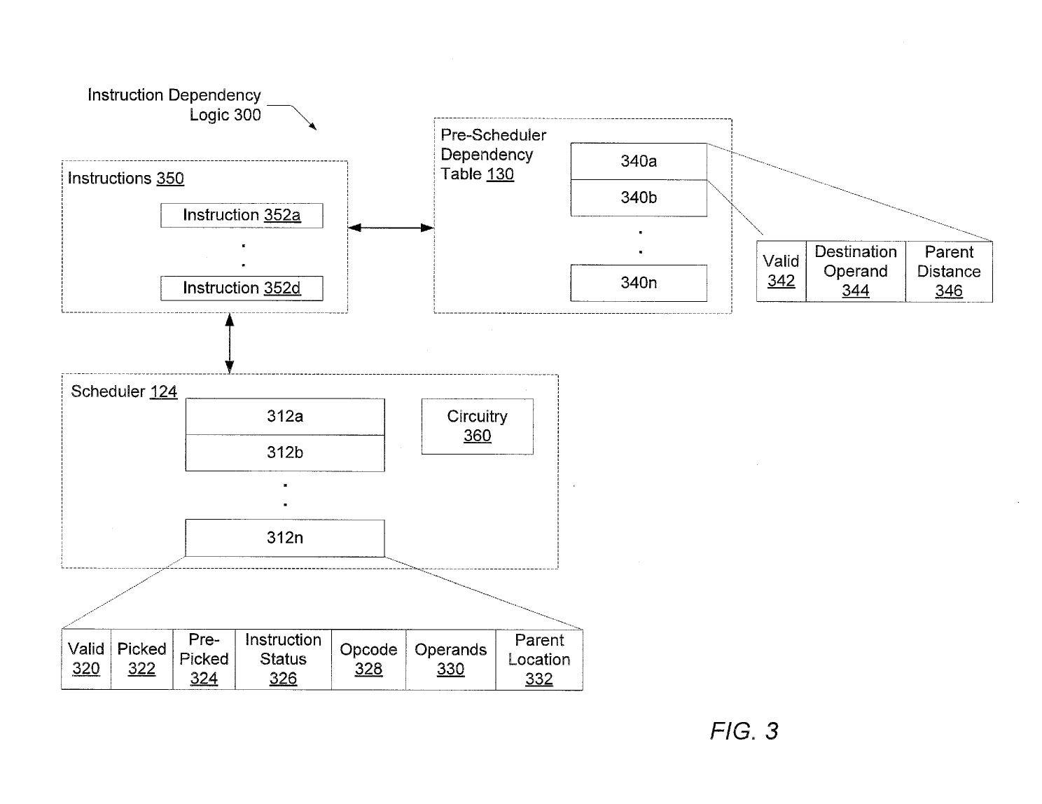

Turning now to FIG. 3, one embodiment of instruction dependency logic 300 across multiple pipe stages is shown. In one embodiment, scheduler 124 holds decoded (and possibly renamed) instructions in processor core 100. The scheduler 124 may comprises entries 312a-312n for storing decoded instructions waiting to be issued to a corresponding execution unit. As used herein, elements referred to by a reference numeral followed by a letter may be collectively referred to by the numeral alone. For example, entries 312a-312n may be collectively referred to as entries 312. In addition, the scheduler 124 may comprise circuitry 360 for performing logic to determine which instructions are eligible for issue, to allocate and deallocate one or more entries of the entries 312 per clock cycle, and to determine which eligible instructions should be issued in a subsequent clock cycle.

The buffered instructions in the scheduler 124 may include micro-operations, or micro-ops, if core 100 is configured to support such operations. The entries 312 may store age information, dependency information, status information and characteristic information of decoded and renamed instructions. Each entry 312 may include a valid field 320, a picked field 322, a pre-picked field 324, an instruction status field 326, an opcode field 328, a field 330 for destination and source operands, and a pointer or reference stored in a parent location field 332. Although the fields are shown in this particular order, other combinations are possible and other or additional fields may be utilized as well. The bits storing information for the fields 320-332 may or may not be contiguous depending on design trade-offs.

In one embodiment, an entry number, which may or may not be stored in a field, corresponds to the position of an entry in the scheduler 124. The entry number may be implied rather than an actual stored number. Entry 0 may be configured to be at the top of the scheduler 124 or at the bottom depending on logic preferences. In one embodiment, the entries 312 may be dynamically allocated in a previous (e.g., renaming) pipe stage. The scheduler 124 may be fully associative or entries may be statically allocated depending on design trade-offs. The valid field 320 may be updated with a value to indicate a valid entry when the entry is allocated. The valid field 320 may be reset to a value indicating an empty entry when the entry is deallocated.

The picked field 322 may be used to indicate a corresponding instruction has been picked. If the entry is deallocated immediately after a clock cycle wherein a corresponding instruction is picked, then the picked field 322 may not be utilized. From the point-of-view of a younger in program order instruction, the absence of an older instruction in the scheduler may denote the older instruction has been picked and issued. In addition, logic may set a corresponding signal called picked for the older instruction to be used in logic for younger instructions in the same clock cycle that the older instruction is picked. However, in the subsequent clock cycle, the picked value is not stored since the older instruction may be deallocated as it is issued. The status field 326 may contain additional information regarding the corresponding instruction.

The pre-picked field 324 may store an asserted value for a corresponding child instruction when a corresponding parent instruction is picked. Alternatively, the pre-picked field 324 may be referred to as an eligible field 324, since a corresponding child instruction may now be eligible to be picked for issue. The location of the parent instruction within scheduler 124 may be identified via the use of the parent location field 332. The parent location field 332 may store a relative reference value or an absolute reference value. For example, the parent location field 332 may store a distance value, such as a count of a number of instructions the parent instruction is away from the child instruction in program order. Alternatively, the parent location field 332 may store an absolute pointer, such as an entry number.

The status field 326 may contain additional information regarding the corresponding instruction. One example is a stalled bit that prevents a corresponding instruction from being picked. This stalled bit may be used to remove instructions from instruction pick consideration while allowing other instructions stored in the scheduler 124 to be considered for instruction pick for a given hardware resource.

Instructions 350 comprise one or more instructions 352 depending on the width of the front end of the pipeline. For example, a fetch unit, a decode unit and a rename unit may process multiple instructions per clock cycle. The number of instructions these units are able to process per clock cycle is the width of the front-end pipeline. During a predetermined pipe stage prior to allocation in the scheduler 124, these instructions may access the pre-scheduler dependency table 130. Table 130 comprises entries 340. As the number of entries 340 within table 130 increases, the window of opportunity to detect a data dependency between a parent instruction and a child instruction also increases. However, the hardware cost of supporting this window also increases. In another embodiment, the pre-scheduler dependency table 130 is not utilized. In such an embodiment, during a pipe stage prior to allocation in the scheduler 124, combinatorial logic may access pipeline registers associated with one or more pipe stages. By accessing these pipeline registers, the logic may compare the source operands of the one or more instructions 352 to the destination operands of older instructions. As the number of older instructions per pipe stage and the number of pipe stages used for these comparisons increase, the window of opportunity to detect a data dependency between a parent instruction and a child instruction also increases. However, the hardware cost of supporting this window also increases.

The data described here as being stored in table 130 may be alternatively stored within pipeline registers in the processor pipeline. Each entry 340 within table 130 may comprise a valid field 342, a destination operand field 344, and a parent location field 346. Similar to the scheduler 124, although the fields are shown in this particular order, other combinations are possible and other or additional fields may be utilized as well. The bits storing information for the fields 342-346 may or may not be contiguous. In a predetermined pipe stage, each instruction 352 may access table 130 and determine whether a data dependency exists with a parent instruction by comparing source operands with each of the destination operand fields 344. A hit indicates a data dependency on a corresponding parent instruction. The valid field 342 may indicate an invalid entry if a corresponding instruction does not produce a result to be stored in a register file, such as control flow instructions.

The parent location field 346 may indicate an entry number corresponding to an entry 312 within scheduler 124. Alternatively, the parent location field may indicate an offset position relative to other entries within table 130. This offset may be combined with a position in program order offset of an instruction 352 relative to other instructions 352. Therefore a distance between the parent instruction and the child instruction may be determined. These offset values may be implied since the front end pipeline is in-order and no parent location field 346 may actually be stored. Other methods and mechanisms for determining a location of a corresponding parent instruction are possible and contemplated.

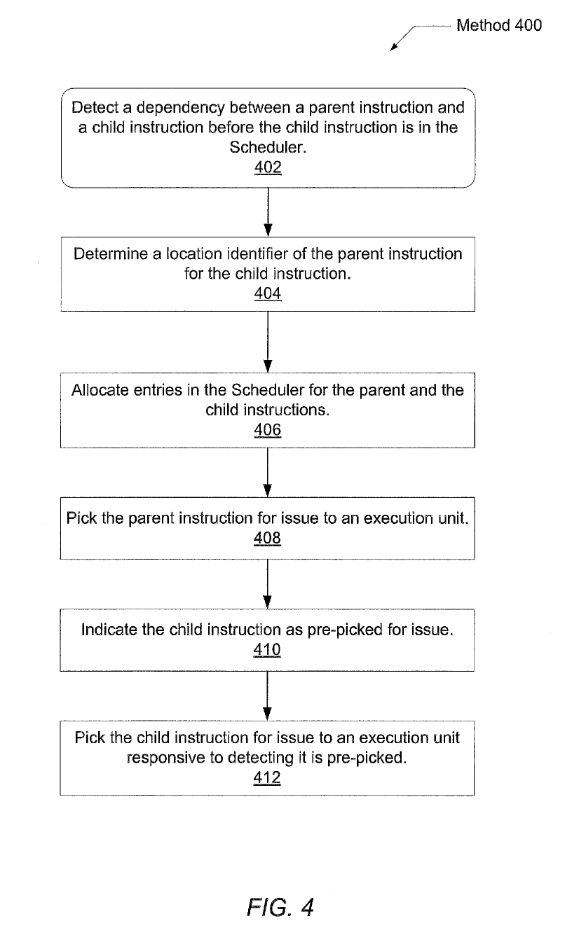

Referring now to FIG. 4, one embodiment of a method 400 for reducing latency of a multi-cycle scheduler is shown. For purposes of discussion, the steps in this embodiment are shown in sequential order. However, some steps may occur in a different order than shown, some steps may be performed concurrently, some steps may be combined with other steps, and some steps may be absent in another embodiment.

One or more applications are executed on a processor core. Corresponding instructions are fetched and processing begins such as decoding, renaming, and so forth. In block 402, prior to a scheduling pipe stage, the processor may detect a data dependency between two instructions, wherein the older in program order instruction may be referred to as a parent instruction and the younger in program order instruction may be referred to as a child instruction. Access of a pre-scheduler dependency table 130 as described earlier may be used. Alternatively, accessing pipeline registers corresponding to one or more pipe stages may be used.

In block 404, a location identifier of the parent instruction may be determined for the child instruction. In one embodiment, the location identifier may comprise a distance between the parent instruction and the child instruction. The distance may be measured as a number of instructions the parent instruction is located from the child instruction in program order. In another embodiment, the location identifier may comprise an absolute pointer to an entry in the scheduler 124 allocated to the parent instruction. In block 406, entries in a scheduler may be allocated for the parent and the child instructions. It is noted the parent instruction may already be allocated in the scheduler 124. In such an example, a corresponding entry number may be used as the location identifier. In block 408, the parent instruction may be picked by the scheduling logic for issue to an execution unit. In a same clock cycle as the parent instruction being picked, in block 410, the child instruction may be pre-picked for issue. The scheduling logic may utilize the location information determined in block 404 and detect the parent instruction is picked. The location information may reduce the number of levels of logic for the scheduling logic, as a data dependency is not determined in this clock cycle. In block 412, the child instruction may be picked for issue to an execution unit in the immediate subsequent clock cycle responsive to detecting it is pre-picked. Additional qualifications may be determined such as a readiness of other source operands, an age of other eligible instructions competing for a same hardware resource, and so forth. However, the scheduling logic itself is not gating the throughput of the child instruction such as utilizing an extra clock cycle to determine data dependencies.

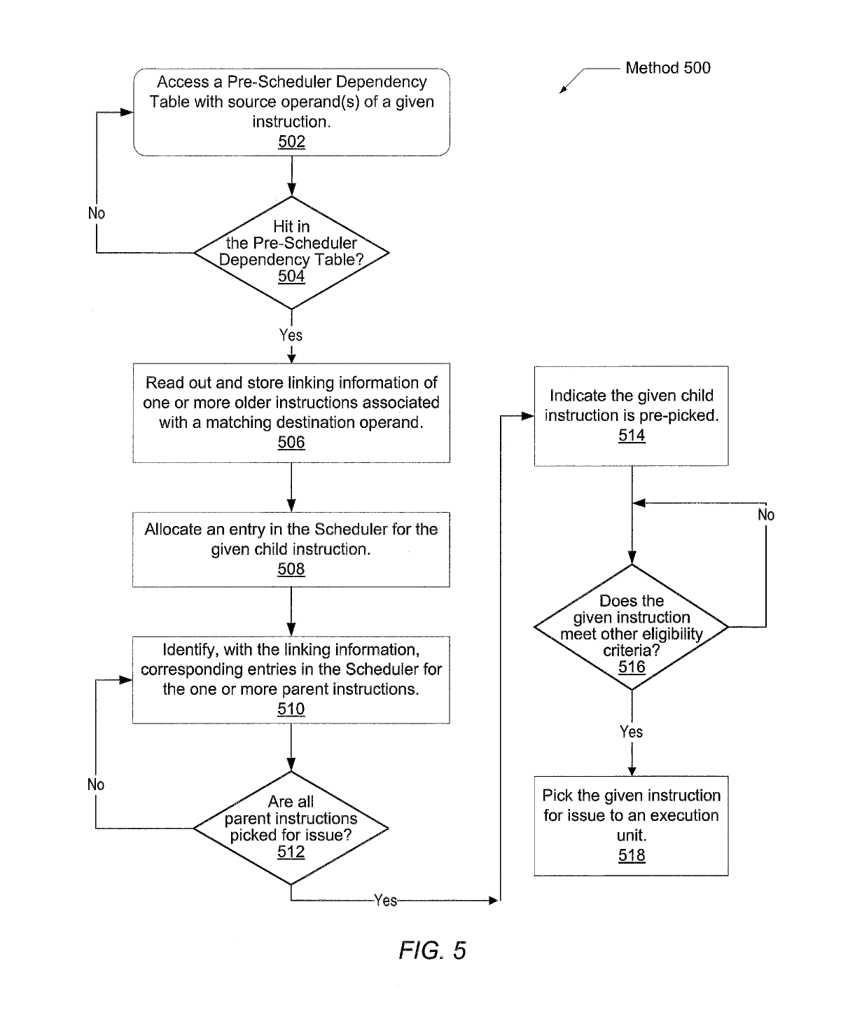

Turning now to FIG. 5, another embodiment of a method 500 for reducing latency of a multi-cycle scheduler is shown. For purposes of discussion, the steps in this embodiment are shown in sequential order. However, some steps may occur in a different order than shown, some steps may be performed concurrently, some steps may be combined with other steps, and some steps may be absent in another embodiment.

One or more applications are executed on a processor core. Corresponding instructions are fetched and processing begins such as decoding, renaming, and so forth. In block 502, each decoded instruction of one or more decoded instructions in a particular pipe stage access a pre-scheduler dependency table. The access may include comparing one or more source operands of a given instruction with destination operands stored in the table. For a given decoded instruction, if a hit occurs during the comparisons (conditional block 504), then in block 506, linking information of one or more older instructions associated with a matching destination operand are read out and stored. The stored linking information may flow down the pipeline with the given child instruction. The amount of linking information to store may depend on the latency of the scheduler, the size of the scheduler, and the size of the pre-scheduler dependency table. Linking information for each source operand for a given child instruction may be stored.

In block 508, a given child instruction has an entry allocated in the scheduler allocated. If scheduling logic detects at least one corresponding parent instruction is picked for a dependent source operand of the given child instruction while other source operands are indicated as ready (conditional block 512), then in block 514, the given child instruction is marked in the scheduler as pre-picked. Alternatively, the given child instruction may be marked as pre-picked as it is being written in a corresponding scheduler entry, rather than afterward. In a subsequent clock cycle, if the pre-picked child instruction meets other eligibility criteria (conditional block 516), then in block 518, the pre-picked child instruction is picked for issue to a corresponding execution unit.

Satisfying other eligibility criteria may include at least being an oldest instruction of a pool of eligible instructions competing for a hardware resource and being in a path that is not stalled.

It is noted that the above-described embodiments may comprise software. In such an embodiment, the program instructions that implement the methods and/or mechanisms may be conveyed or stored on a computer readable medium. Numerous types of media which are configured to store program instructions are available and include hard disks, floppy disks, CD-ROM, DVD, flash memory, Programmable ROMs (PROM), random access memory (RAM), and various other forms of volatile or non-volatile storage. Generally speaking, a computer accessible storage medium may include any storage media accessible by a computer during use to provide instructions and/or data to the computer. For example, a computer accessible storage medium may include storage media such as magnetic or optical media, e.g., disk (fixed or removable), tape, CD-ROM, or DVD-ROM, CD-R, CD-RW, DVD-R, DVD-RW, or Blu-Ray. Storage media may further include volatile or non-volatile memory media such as RAM (e.g. synchronous dynamic RAM (SDRAM), double data rate (DDR, DDR2, DDR3, etc.) SDRAM, low-power DDR (LPDDR2, etc.) SDRAM, Rambus DRAM (RDRAM), static RAM (SRAM), etc.), ROM, Flash memory, non-volatile memory (e.g. Flash memory) accessible via a peripheral interface such as the Universal Serial Bus (USB) interface, etc. Storage media may include microelectromechanical systems (MEMS), as well as storage media accessible via a communication medium such as a network and/or a wireless link.

Additionally, program instructions may comprise behavioral-level description or register-transfer level (RTL) descriptions of the hardware functionality in a high level programming language such as C, or a design language (HDL) such as Verilog, VHDL, or database format such as GDS II stream format (GDSII). In some cases the description may be read by a synthesis tool which may synthesize the description to produce a netlist comprising a list of gates from a synthesis library. The netlist comprises a set of gates which also represent the functionality of the hardware comprising the system. The netlist may then be placed and routed to produce a data set describing geometric shapes to be applied to masks. The masks may then be used in various semiconductor fabrication steps to produce a semiconductor circuit or circuits corresponding to the system. Alternatively, the instructions on the computer accessible storage medium may be the netlist (with or without the synthesis library) or the data set, as desired. Additionally, the instructions may be utilized for purposes of emulation by a hardware based type emulator from such vendors as Cadence®, EVE®, and Mentor Graphics®.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A processor comprising:
a front end pipeline configured to fetch and decode a plurality of instructions; and
a scheduler comprising a plurality of entries;
wherein prior to allocation of a child instruction of the plurality of instructions in the scheduler, the front end pipeline is configured to:
determine the child instruction has a data dependency on a parent instruction of the plurality of instructions, wherein the child instruction is younger in program order than the parent instruction; and
identify a location of the parent instruction in the scheduler;
wherein the scheduler is configured to:
store an identification of said location in a first entry of the plurality of entries allocated to the child instruction; and
store an indication in the first entry indicating the child instruction is eligible to be picked for issue, responsive to detecting the parent instruction is picked for issue.

2. The processor as recited in claim 1, wherein the scheduler is further configured to pick the child instruction for issue one clock cycle after the parent instruction is issued, responsive to detecting the child instruction is eligible to be picked for issue.

3. The processor as recited in claim 1, wherein the scheduler is further configured to perform said storing of the indication while allocating the child instruction in the first entry of the plurality of entries.

4. The processor as recited in claim 1, wherein said identification comprises (i) an entry number corresponding to an entry of the plurality of entries allocated to the parent instruction or (ii) a distance measured as a number of instructions the parent instruction is located from the child instruction in program order.

5. The processor as recited in claim 2, wherein the front end pipeline includes a table comprising one or more table entries, wherein each of the one or more table entries is configured to store a separate destination operand identifier corresponding to a given instruction older in program order than the child instruction.

6. The processor as recited in claim 5, wherein, prior to allocation of the child instruction in the scheduler, the front end pipeline is further configured to:
compare each source operand identifier of the child instruction to each destination operand identifier stored in said table; and
determine said data dependency exists by determining a source operand of the child instruction matches a destination operand of the parent instruction.

7. The processor as recited in claim 4, wherein prior to allocation of the child instruction in the scheduler the front end pipeline is further configured to:
compare each source operand identifier of the child instruction to each destination operand identifier stored in a plurality of pipeline registers associated with one or more consecutive pipe stages beginning with a pipe stage corresponding with the child instruction; and
determine said data dependency exists by determining a source operand of the child instruction matches a destination operand of the parent instruction.

8. The processor as recited in claim 1, wherein the scheduler is further configured to:
store an indication in a third entry of the plurality of entries to indicate a third instruction is eligible to be picked for issue, responsive to detecting a fourth instruction is picked for issue, wherein the third instruction is dependent on the fourth instruction; and
reset the indication in the third entry, responsive to detecting the fourth instruction is issued and any source operand of the third instruction is not ready.

9. A method for use in a processing device, the method comprising:
wherein prior to allocation of a child instruction of a plurality of instructions in a scheduler comprising a plurality of entries:
determining the child instruction has a data dependency on a parent instruction of the plurality of instructions, wherein the child instruction is younger in program order than the parent instruction; and
identifying a location of the parent instruction in the scheduler;
storing an identification of the location in a first entry of the plurality of entries, wherein the first entry is allocated to the child instruction; and
storing an indication in the first entry indicating the child instruction is eligible to be picked for issue, responsive to detecting the parent instruction is picked for issue.

10. The method as recited in claim 9, further comprising picking the child instruction for issue one clock cycle after the parent instruction is issued, responsive to detecting the child instruction is eligible to be picked for issue.

11. The method as recited in claim 9, further comprising perform said storing of the indication while allocating the child instruction in the first entry of the plurality of entries.

12. The method as recited in claim 9, wherein said identification comprises (i) an entry number corresponding to an entry of the plurality of entries allocated to the parent instruction or (ii) a distance measured as a number of instructions the parent instruction is located from the child instruction in program order.

13. The method as recited in claim 10, wherein the front end pipeline includes a table comprising one or more table entries, wherein each of the one or more table entries is configured to store a separate destination operand identifier corresponding to a given instruction older in program order than the child instruction.

14. The method as recited in claim 13, wherein prior to allocation of the first instruction in the scheduler, the method further comprises:
comparing each source operand identifier of the child instruction to each destination operand identifier stored in said table; and
determining said data dependency exists by determining a source operand of the child instruction matches a destination operand of the parent instruction.

15. The method as recited in claim 12, wherein prior to allocation of the child instruction in the scheduler, the method further comprises:
comparing each source operand identifier of the child instruction to each destination operand identifier stored in a plurality of pipeline registers associated with one or more consecutive pipe stages beginning with a pipe stage corresponding with the child instruction; and
determining said data dependency exists by determining a source operand of the child instruction matches a destination operand of the parent instruction.

16. The method as recited in claim 9, further comprising:
storing an indication in a third entry of the plurality of entries to indicate a third instruction is eligible to be picked for issue, responsive to detecting a fourth instruction is picked for issue, wherein the third instruction is dependent on the fourth instruction; and
resetting the indication in the third entry, responsive to detecting the fourth instruction is issued and any source operand of the third instruction is not ready.

17. A computer readable medium comprising instructions which are operated upon by a program executable on a computer system, the program operating on the instructions to perform a portion of a process to fabricate an integrated circuit including circuitry described by the instructions, the circuitry being configured to:
wherein prior to allocation of a child instruction of a plurality of instructions in a scheduler comprising a plurality of entries:
determine the child instruction has a data dependency on a parent instruction of the plurality of instructions, wherein the child instruction is younger in program order than the parent instruction; and
identify a location of the parent instruction in the scheduler;
store an identification of said location in a first entry of the plurality of entries, wherein the first entry is allocated to the child instruction; and
store an indication in the first entry indicating the child instruction is eligible to be picked for issue, responsive to detecting the parent instruction is picked for issue.

18. The storage medium as recited in claim 17, wherein the program instructions are further executable to pick the child instruction for issue one clock cycle after the parent instruction is issued, responsive to detecting at least the child instruction is eligible to be picked for issue.

19. The storage medium as recited in claim 17, wherein the program instructions are further executable to perform said storing of the indication while allocating the child instruction in the first entry of the plurality of entries.

20. The storage medium as recited in claim 17, wherein said identifier comprises (i) an absolute entry number corresponding to an entry of the plurality of entries allocated to the parent instruction or (ii) a distance measured as a number of instructions the parent instruction is located from the first instruction in program order.
